(19) United States
(12) Patent Application Publication
(10) Pub. No.: US 2008/0001929 A1
(43) Pub. Date: Jan. 3, 2008

(54) Touch panel system and method for activation thereof

(76) Inventor: Thomas Wulff, North Patchogue, NY (US)

Correspondence Address: FAY KAPLUN & MARCIN, LLP, 15O BROADWAY, SUITE 702, NEW YORK, NY, 10038, US

(21) Appl. No.: 11/478,963

(22) Filed: Jun. 28, 2006

(51) Int. Cl. G06F 3/042

(52) U.S. Cl. 345/175

(57) ABSTRACT

Described is a system and method for actuating an infrared touch panel. The mobile device may include an infrared touch panel and a housing having a window opening which provides an access to at least a portion of a surface of the touch panel. The system may also include a plurality of light sources disposed along a perimeter of the touch panel so that light beams emitted by the light sources traverse the surface of the touch panel and at least one sensor that detects first data. The first data includes spatial orientation data and motion data of at least one of the touch panel and the device. In addition, the system may also include a processor which compares the first data to second data to determine an occurrence of an event related to at least one of the touch panel and the device. The second data includes predetermined threshold ranges of changes in the spatial orientation data and the motion data. If the event occurrence is detected, the processor selects a predetermined procedure to control at least one of the light sources and the touch panel as a function of one of (i) the first data or (ii) the first data and the second data, and executes the selected procedure.

### FIELD OF THE INVENTION

The present application generally relates to systems and methods for activating a display infrared touch panel on a mobile computing device.

### BACKGROUND INFORMATION

Mobile computing devices(e.g., scanners, PDAs, portable game consoles, mobile phones, laptops, etc.) utilize active touch panels positioned over their display. This enables the user to have direct and instantaneous interaction to input data relative to the displayed information and applications on the mobile device. Touch panels are available in several different technologies. The majority of mobile computers today utilize resistive touch panels since they only require a small amount of battery power during the touch activation process.

Resistive touch panels are constructed of several layers. The upper layers are thin metallic electrically conductive and resistive layers that, when touched, causes a change in the electrical current and registers as a touch event. These thin upper layers are susceptible to user abuse and wear. Also, when compared to a clear display window, the resistive touch panels offer a lower optical transmissivity (clarity) due to their conductive switching layers. An alternate touch panel technology, infrared (IR), utilizes a one piece clear window, replacing the resistive touch panel's fragile thin layers and thereby offering the mobile device user a more durable solution. In addition, the IR touch panel utilizes a clear display window and eliminates the conductive switching layers, thereby enabling a higher level of optical transmissivity for viewing the mobile device display.

The IR touch panel uses a set of light-emitting diodes (LEDs) positioned around the perimeter of the touch panel that shoot beams of light across the surface of the touch panel window to detect a user's touch. However, the LEDs are continually powered so long as the mobile device remains powered, resulting in unnecessary drainage of battery power and accidental touch input. Since mobile devices have limited battery power, this has been the primary issue of incorporating them into mobile devices in the past.

### SUMMARY OF THE INVENTION

The present invention relates to a system and method for actuating an infrared touch panel. The mobile device may include an infrared touch panel and a housing having a window opening which provides an access to at least a portion of a surface of the touch panel. The system may also include a plurality of light sources disposed along a perimeter of the touch panel so that light beams emitted by the light sources traverse the surface of the touch panel and at least one sensor detecting first data. The first data includes spatial orientation data and motion data of at least one of the touch panel and the device.

In addition, the system may also include a processor which compares the first data to second data to determine an occurrence of an event related to at least one of the touch panel and the device. The second data includes predetermined threshold ranges of changes in the spatial orientation data and the motion data. If the event occurrence is detected, the processor selects a predetermined procedure to control at least one of the light sources and the touch panel as a function of one of (i) the first data or (ii) the first data and the second data, and executes the selected procedure.

### BRIEF DESCRIPTION OF THE DRAWINGS

FIG. 1 shows an exemplary embodiment of an infrared touch panel system according to the present invention.

FIG. 2 shows an exemplary embodiment of a method for monitoring an infrared touch panel system according to the present invention.

### DETAILED DESCRIPTION

The present invention may be further understood with reference to the following description and the appended drawings, wherein like elements are provided with the same reference numerals. The exemplary embodiments of the present invention relate to an IR touch panel and at least one sensor that monitors spatial orientation and motion of the mobile device. In particular, the sensor(s) may measure the mobile device's acceleration, velocity, angular velocity/acceleration in any direction, orientation with respect to the user or any other motion to which the mobile device may be subjected. These measurements may be contrasted with prerecorded motion patterns or predefined levels of motion. As will be described below, predetermined procedures may then be executed in response to the orientation/motion for adjusting functionality of the IR touch panel.

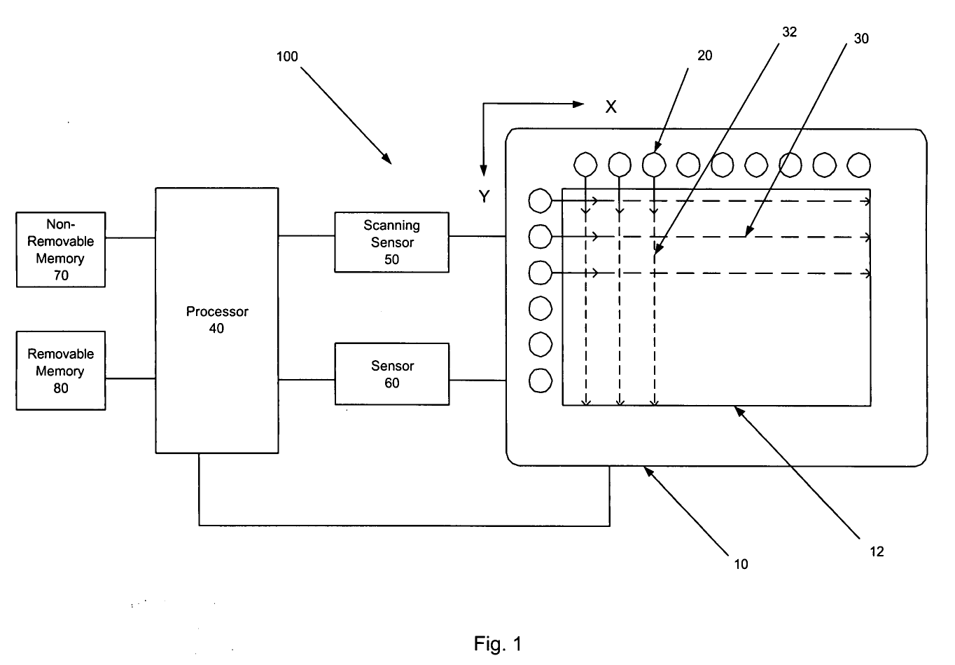

FIG. 1 shows an exemplary embodiment of a system according to the present invention. The system may be implemented in any type of processor-based mobile device 100 which may include a laser-/imager-based scanner, an RFID reader, a PDA, a mobile phone, a laptop, a tablet computer, a portable gaming device, a digital media player, a digital camera, etc. In the exemplary embodiment, the mobile device 100 may comprise a housing 10 with an infrared (IR) touch panel 12. The IR touch panel 12 includes a plurality of light sources 20 disposed along X and Y axes of the perimeter of housing 10. The light sources 20 are configured so that horizontal 30 and vertical light beams 32 are emitted across a surface of the IR touch panel 12, thus, creating a grid-like pattern.

The mobile device 100 may further include a processor 40, light source scanning sensors 50, one or more orientation/motion detection sensors 60, a non-removable memory 70 and a removable memory 80. The processor 40 is a central processing unit (CPU) that executes instructions and processes data, e.g., coordinates detected by the scanning sensors 50, measurements generated by the sensors 60, etc. The scanning sensors 50 detect interruptions of the light beams 30 and 32, and determine coordinates corresponding to the interruptions. The processor 40 uses the coordinates of the interruptions along with knowledge of content shown on the IR touch panel 12 to determine a procedure(s) to execute.

The non-removable memory 70 may be any type of memory component integral with the mobile device 100 and may be temporary (e.g., random access memory, or RAM) and/or permanent (e.g., a hard-disk drive). The removable memory 80 may be any type of detachable memory component that may connect to the mobile device 100 through an expansion interface (e.g., a FLASH interface, a USB interface, a firewire interface, etc.).

The sensors 60 may be any type of measurement devices capable of monitoring spatial orientation and motion, and may be based on, for example, a G-shock sensor, a switch, an accelerometer, a strain gage, a piezo, MEMS technologies, or combinations of the like. The spatial orientation may include any angular movement with respect to at least one axis in the three-dimensional reference frame of the mobile device 100. The motion may include, for example, a velocity value, an acceleration value, an angular acceleration/velocity value, etc. Although the sensors 60 may be of any size, they are preferably small enough so that any added weight and space occupied on the mobile device 100 is negligible. Because the mobile device 100 usually operates on batteries, the sensors 60 should preferably have a low power consumption.

The sensors 60 detect changes in the spatial orientation and motion of the mobile device 100 and generate first data. The first data is provided to the processor 40 which compares the first data to predetermined second data that includes threshold ranges and/or values. For example, the second data may be a prerecorded rotation of the mobile device 100 by 900, the detection of which may indicate occurrence of an event. The second data may be a threshold range of angular ranges and/or threshold values. Thus, when the first data indicates that the mobile device 100 has rotated past the range or threshold, the processor 40 selects and executes a predetermined procedure.

The first data may be retained for each instance where the measurements of the sensors 60 are outside of the threshold ranges or greater than the value, which would be indicative of an event. The processor 40 may also append additional information to the retained first data including sequential numbering of the events, time and date for each event, acceleration data, data corresponding to a status of the IR touch panel 12 at the date/time of the event, etc.

In the exemplary embodiment of the present invention, the processor 40 selectively activates the light sources 20 based on a comparison of first and second data. During use, the mobile device 100 may be held in the user's hand with the display screen 12 being viewable by the user. However, when not in use, the mobile device 100 may be tethered to the user's belt or motionless. If the mobile device 100 is not powered off, the light sources 20 of the IR touch panel 12 may be powered while tethered to the user's belt, wasting battery power and increasing the chances of accidental touch panel inputs.

In the exemplary embodiment of the present invention, the first data generated by the sensors 60 is used by the processor 40 to activate and deactivate the light sources 20. For example, when the first data indicates that the IR touch panel 12 is viewable by the user, the light sources 20 may be activated. When the first data indicates that the mobile device 100 is tethered to the user's belt, motionless, or otherwise in an orientation in which the IR touch panel 12 is not viewable by the user, the light sources 20 may be deactivated.

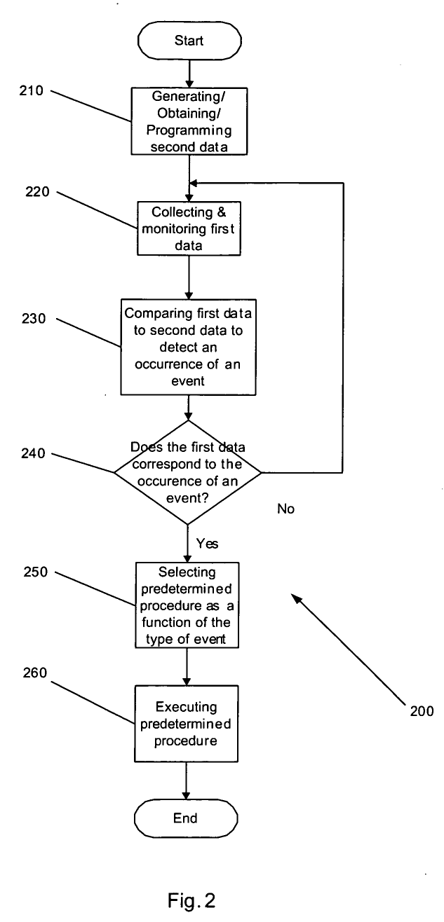

FIG. 2 shows an exemplary method 200 for monitoring the mobile device 100. In the step 210, certain distinct characteristics of events (e.g., the second data) are identified and stored by the mobile device 100 as the second data. The second data may include a specific threshold value and/or a threshold range of changes in the spatial orientation and motion of the mobile device 100. The characteristics may include, for example, maximum or minimum threshold values or prerecorded motions. The user (e.g., the manufacturer, a system administrator or any other authorized person) may designate or, if desired, make changes to these characteristics. For instance, the mobile device 100 may be prepackaged by the manufacturer with static maximum values that are inaccessible or not editable by the user. Alternatively, the threshold values may simply be dynamic default values adjustable to future specifications. In addition, the second data may include prerecorded movements/orientations of the mobile device 100, e.g., use of the IR touch panel 12, hanging from the user's belt, IR touch panel 12 in viewable and non-viewable positions with respect to the user, etc.

In the step 220, the sensors 60 collect and monitor the mobile device 100 for changes in the spatial orientation and/or motion that may constitute the occurrence of a predefined event. An event may include, for example, the mobile device 100 being rotated, lifted, put down, inverted, remaining still for a specified duration, etc. When the mobile device 100 experiences detectable motion or an extended lack thereof, the first data is generated. The sensors 60 may make no effort to differentiate between or prioritize directional orientation or motion values, returning all results to the processor 40 for processing.

In the step 230, the processor 40 compares the first data to the second data to determine whether an event has occurred. At an occurrence of the event, the processor 40 may store the first data and attach at least one additional data thereto, e.g., a time/date of each event, a status of the IR touch panel 12, a direction of the acceleration, environmental data, etc. The additional data may be reviewed and used to further refine the second data. For example, if the IR touch panel is not effectively activated or deactivated, the second data may be adjusted based on the recorded first data.

Due to practical considerations (e.g., memory limitations and processing power) and because not all event occurrences may be significant, the reporting and recording of all movements of the mobile device 100 no matter how minor, although possible, may in some instances be impractical. Movements within predefined ranges may not correspond to any of the predefined events and, thus, have no bearing on applications of the present invention. For example, if the user reorients the mobile device 100 to achieve a better view of the display screen 12 (e.g., in a glare), movements corresponding to the reorientation may not register as one of the predefined events. Therefore, in step 240, if the processor 40 determines that an event has occurred (e.g., the first data falls within the threshold values/ranges and/or matches the prerecorded orientations/motions of the second data) the first data is retained. Otherwise, the first data may be discarded and the method 200 returned to the step 220 for the monitoring of new events.

If the first data corresponds to one of the events indicated by the second data, the method 200 continues to step 250 where the processor 40 selects, as a function of the first data or as a function of the first and second data, at least one predetermined procedure for execution. In particular, the processor 40 analyzes the first data and determines the corresponding procedure of the plurality of predetermined procedures, which control at least one of the light sources 20 and the touch panel 12. In the exemplary embodiment, the plurality of predetermined procedures may include, but is not limited to, activating/deactivating the light sources 20, activating/deactivating the IR touch panel 12, adjusting brightness of IR touch panel 12, etc.

In the step 260, the predetermined procedure is executed. For example, when the first data indicates that the mobile device 100 is oriented so that the display screen 12 is viewable by the user, the processor 40 may activate the LEDs, enabling the IR touch panel. When the first data indicates that the mobile device 100 is held at the user's side or tethered to the user's belt, the processor 40 may deactivate the light sources 20.

From the description of the exemplary embodiments of the present invention, one of skill in the art would understand that the sensors 60 allow the mobile device 100 to enable/disable particular functionality automatically based on orientation and/or movement thereof. For example, if the IR touch panel is not needed to input data, the user may simply lower the mobile device 100 down to his/her side to deactivate the light sources 20. Similarly, raising the mobile device 100 may activate the light sources 20 and enable the IR touch panel.

An advantage of the present invention is that it prevents the unnecessary drainage of battery power while decreasing the chances of accidental touch inputs. Another advantage is that it allows the user to keep the device powered on during short periods of non-use, without wasting battery, such that the user does not have to continuously power the device on and off before and after each use. Furthermore, the user saves time by avoiding the time it takes for software to load and for the device to become ready for use.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A mobile device, comprising:
an infrared touch panel;
a housing having a window opening, the window opening providing an access to at least a portion of a surface of the touch panel;
a plurality of light sources disposed along a perimeter of the touch panel so that light beams emitted by the light sources traverse the surface of touch panel;
at least one sensor detecting first data, the first data including spatial orientation data and motion data of at least one of the touch panel and the device; and
a processor comparing the first data to second data to determine an occurrence of an event related to at least one of the touch panel and the device, the second data including predetermined threshold ranges of changes in the spatial orientation data and the motion data,
wherein if the event occurrence is detected, the processor selects a predetermined procedure to control at least one of the light sources and the touch panel as a function of one of (i) the first data or (ii) the first data and the second data, and executes the selected procedure.

2. The device according to claim 1, wherein the predetermined procedure is at least one of (i) activating the light sources in a predetermined view mode and (ii) deactivating the light sources in a predetermined non-view mode.

3. The device according to claim 2, wherein the light sources are activated in the view mode when the first data indicates that an orientation of the device corresponds to a pre-identified orientation indicating that the touch panel is viewable by a user.

4. The device according to claim 2, wherein the light sources are deactivated in the non-view mode when the first data indicates that an orientation of the device corresponds to a pre-identified orientation indicating that the touch panel is not viewable by a user.

5. The device according to claim 4, wherein the device is powered off after the light sources have been deactivated for a predetermined period of time.

6. The device according to claim 1, wherein the motion data includes at least one of a velocity value, an acceleration value, an angular velocity value, and an angular acceleration value.

7. The device according to claim 1, wherein the spatial orientation data includes at least one angular movement value of the arrangement with respect to at least one axis of the device.

8. The device according to claim 1, wherein the plurality of sensors include at least one of a G-shock sensor, a switch sensor, an accelerometer, a strain gage, a piezo and a micro-electromechanical sensor (MEMS).

9. The device according to claim 1, wherein the plurality of light sources may include a light emitting diode (LED).

10. The device according to claim 1, wherein the plurality of light sources may be internal or external of the housing.

11. A method comprising the steps of:
collecting, using at least one sensor of a device, first data including spatial orientation data and motion data of at least one of a touch panel and the device, the device having a plurality of light sources and a housing with a window opening, the window opening providing an access to at least a portion of a surface of the touch panel, the light sources being disposed along a perimeter of the touch panel so that light beams emitted by the light sources traverse the surface of touch panel;
comparing the first data to second data to determine an occurrence of an event related to at least one of the touch panel and the device, the second data including predetermined threshold ranges of the changes in the spatial orientation data and the motion data,
if the event occurrence is detected, selecting a predetermined procedure to control at least one of the light sources and the touch panel as a function of (i) the first data or (ii) the first data and the second data; and
executing the selected predetermined procedure.

12. The method of claim 11, further comprising the steps of:
obtaining second data, including threshold ranges of the changes in orientation data and motion data, prior to collecting first data; and
storing the second data in a memory of the device.

13. The method according to claim 11, wherein the predetermined procedure is at least one of (i) activating light sources of the device in a predetermined view mode and (ii) deactivating light sources of the device in a predetermined non-view mode.

14. The method according to claim 13, wherein the light sources are activated in the view mode when the first data indicates that an orientation of the device corresponds to a pre-identified orientation indicating that the touch panel is viewable by a user.

15. The method according to claim 13, wherein the light sources are deactivated in the non-view mode when the first data indicates that an orientation of the device corresponds to a pre-identified orientation indicating that the touch panel is not viewable by a user.

16. The method according to claim 15, wherein the device is powered off after the touch panel has been deactivated for a pre-identified period of time.

17. The method according to claim 11, wherein the motion data includes at least one of a velocity value, an acceleration value, an angular velocity value, and an angular acceleration value.

18. The method according to claim 11, wherein the spatial orientation data includes at least one angular movement value of the arrangement with respect to at least one axis of the device.

19. The method according to claim 11, wherein the plurality of sensors include at least one of a G-shock sensor, a switch sensor, an accelerometer, a strain gage, a piezo and a micro-electromechanical sensor (MEMS).

20. A device, comprising:
a housing means having a window opening for providing an access to at least a portion of a surface of an infrared touch panel;
a light source means disposed along a perimeter of the touch panel for emitting light beams that traverse the surface of the touch panel;
a sensing means for detecting first data, the first data including spatial orientation data and motion data of at least one of the touch panel and the device; and
a processing means comparing the first data to second data to determine an occurrence of an event related to at least one of the touch panel and the device, the second data including predetermined threshold ranges of changes in the spatial orientation data and the motion data,
wherein if the event is detected, the processing means selects a predetermined procedure to control at least one of the light sources and the touch panel as a function of one of (i) the first data or (ii) the first data and the second data, and executes the selected procedure.
